(19) United States
(12) Patent Application Publication
(10) Pub. No.: US 2017/0037281 A1
(43) Pub. Date: Feb. 9, 2017

(54) Alternating Adhesive Tape

(71) Applicant: Glenn C. Johnson, Palm City, FL (US)

(72) Inventor: Glenn C. Johnson, Palm City, FL (US)

(21) Appl. No.: 15/331,399

(22) Filed: Oct. 21, 2016

Related U.S. Application Data
(63) Continuation of application No. 15/004,266, filed on Jan. 22, 2016, now abandoned.
(60) Provisional application No. 62/107,982, filed on Jan. 26, 2015.

(51) Int. Cl. C09J 7/02

(52) U.S. Cl. CPC C09J 7/02; C09J 2201/28

(57) ABSTRACT

An alternating adhesive tape apparatus is described. The device is equipped with alternating sections or segments, an adhesive section and a non-adhesive section. An intermediary section, referred to as a cut-target section, is disposed within the non-adhesive sections. The cut-target section is configured to act as a guideline for cutting the tape for use by the user, and alerting the user of the location of the adhesive sections of the tape visibly. The cut-target sections, as non-adhesive sections of the apparatus, are preferably colored to indicate which portions are not equipped with adhesive, and provide a guide for cutting. The non-adhesive sections are configured to act as a tab or release-tab for the tape after the tape has been cut in or around the cut-target section, releasing the segment from the roll or strip containing the remainder of the adhesive tape apparatus.

### CONTINUITY

This application is a continuation application of non-provisional application Ser. No. 15/004,266, filed on Jan. 22, 2016, which is a non-provisional application of provisional patent application No. 62/107,982, filed on Jan. 26, 2015, and priority is claimed thereto.

### FIELD OF THE PRESENT INVENTION

The present invention relates generally to adhesive devices, and more specifically, adhesive tape devices configured with an adhesive backing on only one side of the adhesive tape device.

### BACKGROUND OF THE PRESENT INVENTION

While there are many forms of adhesives available today, each is generally tailored for a specific purpose or set of purposes. All-purpose adhesive tape, such as Scotch™ brand tape is conventionally clear or translucent, and is equipped with an adhesive lining the entirety of the back side of the tape. The front side is traditionally smooth, and is not equipped with adhesive, except in cases of double-sided adhesive tape. As a general purpose, tape can be used for a variety of projects that involve temporarily binding, via adhesive, of one or more tangible objects to the adhesive tape.

Unfortunately, once applied, most adhesive tapes are difficult to remove, often requiring the user to employ a fingernail or razor blade to scrape up a corner of the tape in order to have a point to grab and lift the tape off of the applied surface. If the tape is left applied for a long period of time, removal becomes even more difficult. Additionally, if the tape is left in the sun while applied to a surface, removal of the tape is also increasingly difficult.

Thus, there is a need for a tape that is easily removable while remaining effective. Such a tape device is preferably equipped with small, tabbed, non-adhesive segments, that, when bifurcated or cut, creates a tab to facilitate easy removal of the tape by hand via the tabbed segment.

### SUMMARY OF THE PRESENT INVENTION

The present invention is an alternative adhesive tape apparatus, equipped with an adhesive on a first side of the adhesive tape, and a smooth side on a second side of the adhesive tape. The adhesive lining the first side of the adhesive tape is positioned such that it does not cover the entirety of the first side of the adhesive tape. Instead, the adhesive of the present invention is configured to be positioned in alternating sections on the first side of the tape. For example, the alternating pattern of adhesive could be present in intervals of one inch. Therefore, after every inch of adhesive backing on the adhesive tape, there shall follow one inch of smooth, non-adhesive equipped tape.

Alternately, in some embodiments of the present invention, the spacing interval between each segment of adhesive on the present invention may vary in size according to the task at hand. The design of the present invention is configured to prevent issues that are common with conventional tape removal.

The tabbed segments of the tape device of the present invention are preferably demarcated with at least one color, and consist of blank tape without adhesive. Each of these segments has at least one marking indicating the ideal placement to cut the tape to create appropriately sized tabbed tape pieces. The tabbed segments are configured to provide a direct means for rapid removal of the present invention.

### BRIEF DESCRIPTION OF THE DRAWINGS

FIG. 1 shows an illustration of the first side of the adhesive tape of the present invention, detailing the alternating portions of adhesive present on the first side of the tape.

FIG. 2 exhibits a view from the top of the second side of the adhesive tape of the present invention, showing the smooth, non-adhesive equipped second side.

FIG. 3 displays the front of an alternate embodiment of the present invention displaying alternate, non-adhesive equipped sides.

FIG. 4 displays the rear of an alternate embodiment of the present invention displaying alternate, non-adhesive equipped sides.

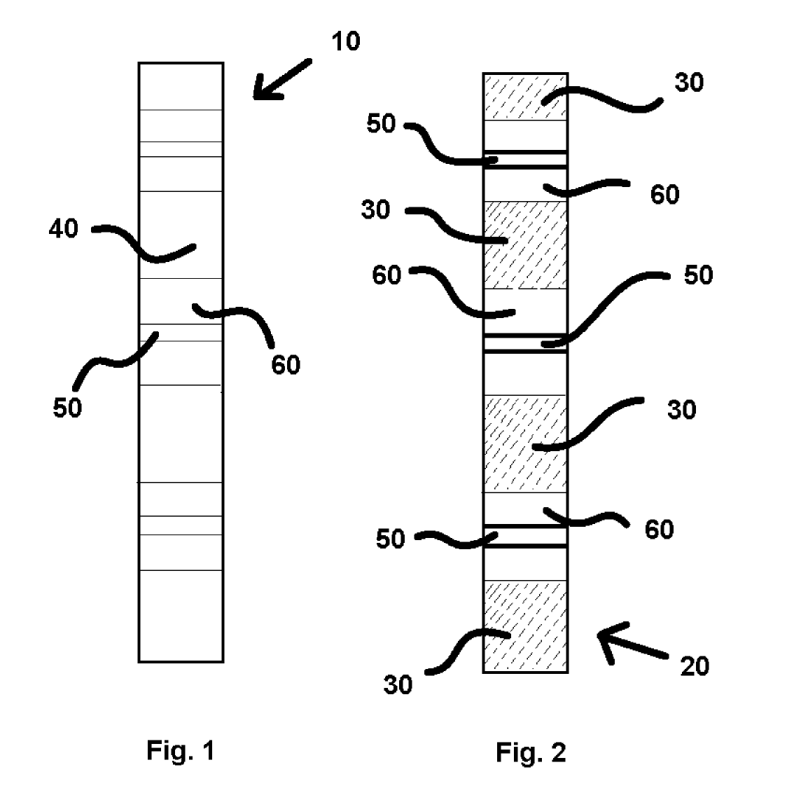

### DETAILED DESCRIPTION OF THE PREFERRED EMBODIMENT

The present invention is an adhesive apparatus device configured to removably adhere to tangible objects. The present invention is equipped with a front side (10) and a rear side (20). The present invention is divided into two primary sections: an adhesive section (40) and a non-adhesive section (60). A cut target section (50) is disposed within the non-adhesive section (60) of the present invention to delineate ideal cut points of the present invention. The rear side (20) of the present invention is equipped with an adhesive (30) lining the adhesive sections (40) of the present invention. The adhesive (30) does not preferably extend to the non-adhesive section (60) of the present invention.

The cut target section (50) is preferably disposed between two non-adhesive sections (60). More than one color may be employed within the cut target section (50) to delineate different sizes of tabbed tape that can be cut if the cut is made along the specified colored line. For example, a cut on a blue line may yield 1 inch of adhesive section (40) and ⅜ inch of non-adhesive section (60), whereas a cut on a red line may yield one inch of adhesive section (40) and ⅗ in non-adhesive section (60). Some cut target sections (50) of the present invention may be equipped with perforations to allow cutting with safer tape dispensers equipped with a dull cutting surface or mechanism. Sufficient perforation may be used to allow the present invention to be cut without use of a tool. It is envisioned that some embodiments of the present invention may be equipped with cut target sections (50) for the adhesive sections (40) and non-adhesive sections (60) that are arranged at a distance appropriate for using tape for wrapping gifts with a minimal amount of tape.

Similar to conventional tapes, the present invention is equipped with parallel edges. The width of the present invention or the spacing between these parallel edges may vary with the intention for the present invention. As such, the present invention is envisioned to be available in a wide variety of colors and widths.

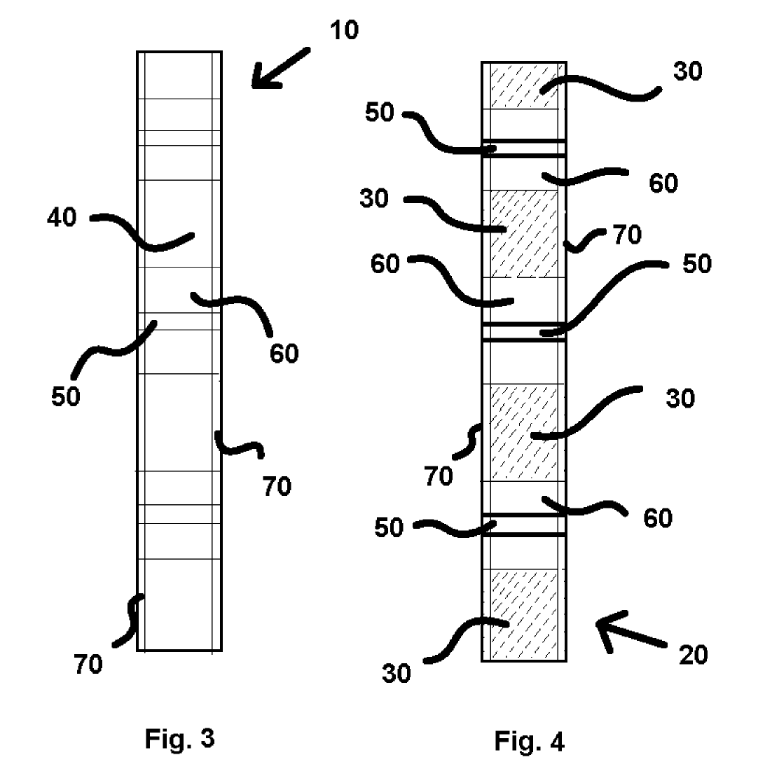

Some embodiments of the present invention are equipped with adhesive-free edges (70), as seen in FIG. 3 and FIG. 4. Therefore, alternate embodiments may be configured such that the adhesive (30) on the rear side (20) of the adhesive sections (40) of the present invention does not extend to the parallel edges of the tape, leaving adhesive-free edges (70) as a border to the tape. Adhesive-free edges (70) of the present invention help to prevent tape tangling or crossing, and to make grasping the tape easier. The adhesive-free edges (70) leave a small buffer between the edge of the tape and the adhesive (30) on the rear side (20) of the adhesive sections (40) of the present invention. This facilitates removal of the tape from the affixed surface or object if and when removal is required.

Additional embodiments of the present invention are equipped with additional instances of cut target sections (50) that are shown as colored lines. Each of the lines of the additional cut target sections (50) are demarcated with a differently colored line, each to indicate a specific length of tape to be available if the specified colored line is cut upon. It is similarly envisioned that, in lieu of simply a line of color to demarcate the cut target sections (50) of the present invention, entire segments of tape may be colored and/or striped to indicate where to cut the tape for a specified length. Additionally, it is envisioned that the present invention may employ tearable or easy-tear tape that may easily be torn in specific sections, rather than require the use of scissors or a tape dispenser to separate portions of the present invention along the cut target sections (50). Other embodiments of the present invention may employ a thicker, more rigid form of tape medium, and may be written on with ink-based pens or similar writing instruments.

Additional alternate embodiments of the present invention may also include variations on the composition of the present invention. For example, it is envisioned that some embodiments of the present invention may be equipped with rope, string (80), or other similar filaments to increase the tactile strength of the present invention. In such embodiments, it is envisioned that the string (80) or filament is disposed such that it extends throughout the entirety of the tape, extending from end-to-end length-wise. Additionally, in such alternate embodiments, it is envisioned that the string (80) or filament be colored a contrasting color to that of the tape. For example, the tape could be white in color, and the filaments or string (80) could be colored pink or yellow. Such string (80) or filament is preferably only used on paper tape embodiments of the present invention. It is similarly envisioned that such string (80) or filament embedded within or on the tape of the present invention could be used to facilitate removal of the tape after application, and/or may be used to cut through the tape when pulled to expedite the opening of a box or similar item secured by the present invention.

It should be noted that, in one embodiment of the present invention, it is envisioned that the non-adhesive sections (60) and cut target sections (50) of the present invention are crinkled, embossed, or otherwise textured. The non-adhesive sections (60) and/or the cut target sections (50) are crinkled or otherwise texturized in order to facilitate a sturdy, expedient grip of the present invention, easing removal of the present invention from the applied surface.

Having illustrated the present invention, it should be understood that various adjustments and versions might be implemented without venturing away from the essence of the present invention. Further, it should be understood that the present invention is not solely limited to the invention as described in the embodiments above, but further comprises any and all embodiments within the scope of this application.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

I claim:

1. A method of deploying an alternating adhesive tape comprising:
procuring the alternating adhesive tape in roll form;
gripping an end of the alternating adhesive tape;
pulling the end, unrolling the alternating adhesive tape a desired amount;
identifying a cut target section delineated with a colored segment;
wherein the cut target section is equipped with a first colored line and a second colored line;
wherein the rear of the alternating adhesive tape spanning the cut target section is not equipped with adhesive embodying a non-adhesive segment;
detaching a segment of the alternating adhesive tape from the roll at the first colored line of the cut target section;
wherein the first colored line delineates a first predefined tape cut length;
wherein the second colored line delineates a second predefined tape cut length;
wherein the detached segment of the alternating adhesive tape has parallel edges;
wherein the adhesive on the rear of the alternating adhesive tape does not extend to all edges of the alternating adhesive tape;
positioning the detached segment in a desired position;
affixing the alternating adhesive tape to a desired surface via the adhesive;
gripping the non-adhesive section; and
removing the alternating adhesive tape manually via the non-adhesive section.

2. The method of claim 1, wherein the non-adhesive section is textured.

3. The method of claim 1, wherein the non-adhesive section is crinkled.

4. The method of claim 1, wherein the first colored line and second colored line are perforated.

5. The method of claim 1, wherein the color of the alternating adhesive tape contrasts that of the color of the first colored line and second colored line.

6. The method of claim 1, wherein the alternating adhesive tape is equipped with embedded filament; and
wherein the embedded filament is of a contrasting color to that of the alternating adhesive tape, first colored line, and second colored line.

7. A method for using tape equipped with alternating adhesive segments and non-adhesive segments comprising:
procuring a roll of alternating adhesive tape;
gripping an end of the alternating adhesive tape;
pulling the end of the alternating adhesive tape, unrolling the alternating adhesive tape to a desired length;
identifying a cut target section delineated with a colored segment;
wherein the cut target section is equipped with a first colored line and a second colored line;
wherein the rear of the alternating adhesive tape spanning the cut target section is not equipped with adhesive embodying a non-adhesive segment;
detaching a segment of the alternating adhesive tape from the roll at the first colored line of the cut target section;
wherein the first colored line delineates a first predefined tape cut length;
wherein the second colored line delineates a second predefined tape cut length;
wherein the detached segment of the alternating adhesive tape has parallel edges;
wherein the adhesive on the rear of the alternating adhesive tape does not extend to all edges of the alternating adhesive tape;
positioning the detached segment in a desired position;
affixing the alternating adhesive tape to a desired surface via the adhesive;
gripping the non-adhesive section;
removing the alternating adhesive tape manually via the non-adhesive section;
wherein the first colored line and second colored line are perforated;
wherein the alternating adhesive tape is equipped with at least one embedded filament; and,
wherein the at least one embedded filament is of a contrasting color to that of the alternating adhesive tape, first colored line, and second colored line.

8. The method of claim 3, wherein the first colored line and second colored line are perforated.

9. The method of claim 4, wherein the color of the alternating adhesive tape contrasts that of the color of the first colored line and second colored line.
